(19) United States
(12) Patent Application Publication
(10) Pub. No.: US 2013/0145434 A1
(43) Pub. Date: Jun. 6, 2013

(54) Unattended Authentication in a Secondary Authentication Service for Wireless Carriers

(71) Applicants: William Wells, Federal Way, WA (US); Yoogin Lean, Apex, NC (US); Keith A. McFarland, Annapolis, MD (US)

(72) Inventors: William Wells, Federal Way, WA (US); Yoogin Lean, Apex, NC (US); Keith A. McFarland, Annapolis, MD (US)

(21) Appl. No.: 13/706,515

(22) Filed: Dec. 6, 2012

Related U.S. Application Data
(60) Provisional application No. 61/567,272, filed on Dec. 6, 2011.

(51) Int. Cl. H04W 12/06

(52) U.S. Cl. CPC H04W 12/06
USPC 726/4

(57) ABSTRACT

A wireless device initiates a connection by sending an Unsolicited HTTP(s) POST that includes a user identity and credentials, not in response to a form that is provided to the wireless device from a secondary authentication service (2AS), so the 2AS does not have a session with the wireless device. An HTTP(s) session is handled by a home agent or enterprise home agent. The 2AS uses the user identity and credentials from the Unsolicited POST to complete interaction with a downstream identity management server, and takes appropriate action by either indicating to the home agent that authentication was successful and the device is authorized to use the private enterprise network resources protected by the 2AS process; or if the authentication was unsuccessful that the session(s) should be disconnected. In addition, the 2AS may communicate with the agent on the wireless device to send intermediate and final status of the attempt.

The present application claims priority from U.S. Provisional No. 61/567,272, entitled “Unattended Authentication in a Secondary Authentication Service for Wireless Callers” to Wells et al., filed Dec. 6, 2011, the entirety of which is expressly incorporated herein by reference.

### BACKGROUND OF THE INVENTION

1. Field of the Invention

This invention relates generally to telecommunications. More particularly, it relates to telecommunication network device admission security.

2. Background of Related Art

When a wireless device gains access to the carrier's wireless network via the first-level authentication (1AS) there is no provision for authenticating that the user (or client applications) on that device are authorized to use resources on private enterprise networks over and above the use of the carrier's radio network. This service is provided by a network element known as the Secondary Authentication Service (2AS) and can be used to authenticate enterprise mobile devices to authorize them to use the services of private enterprise networks through the mobile carrier's Data Access Control servers.

The current implementations of a 2AS all rely on using HTTP forms to interactively collect the user's identity and credentials to pass this information on to the appropriate authentication directory service. The 2AS acts as an intermediary between the various authentication directory services (e.g., Active Directory, RADIUS, LDAP, DIAMETER etc.) and the user on the device seeking access to the resources.

Bridgewater Systems (http://wwvv.bridgewatersystems.com/Service-Controlleraspx) provides an identity management service. However, most M2M authentication in such a conventional system is likely to be done via RADIUS or DIAMETER protocols.

Also, a Secondary Authentication Service (2AS) is currently commercially available from TeleCommunication Systems, Inc., of Annapolis, Md. (owner of the present application at the time of invention). The main disadvantage to the current technology is that it relies on an interactive process with a human user.

### BRIEF DESCRIPTION OF THE DRAWINGS

Features and advantages of the present invention become apparent to those skilled in the art from the following description with reference to the drawings:

FIG. 1 shows a secondary authentication service unsolicited POST successful operation, in accordance with the principles of the present invention.

FIG. 2 shows a secondary authentication service unsolicited POST unsuccessful operation, in accordance with the principles of the present invention.

FIG. 3 shows exemplary process call flow, in accordance with the principles of the present invention.

### DETAILED DESCRIPTION OF ILLUSTRATIVE EMBODIMENTS

The present inventions solves the issue of the case where a wireless device either has no human user to interact with a secondary Authentication Service (2AS) that can perform an interactive authentication procedure, or a sub-system on a wireless device needs to authenticate without assistance from a human user. This invention enables machine-to-machine (M2M) interface with an otherwise conventional 2AS network element without the need to introduce a specific network element for M2M authentication.

In particular, rather than providing machine-to-machine authentication via a RADIUS or DIAMETER protocol, e.g., as in conventional systems such as that commercially available from Bridgewater Systems (which requires human interaction), the present invention provides machine-to-machine authentication using an HTTP connection.

The invention enables an agent located on a wireless device to send identity and credential information in an HTTP(s) POST operation without first having a session established to the Secondary Authentication Service (2AS).

The current call flow for a secondary Authentication Service (2AS) has the wireless device connected to a Home Agent (HA) or Enterprise Home Agent (EHA). The purpose of the home agent or enterprise home agent is to manage data session from a wireless device on the wireless data network. The current 2AS call flow is initiated when a wireless device makes any HTTP request that requires a 2AS to make that connection to the home agent or enterprise home agent. The home agent or enterprise home agent then redirects that session to the appropriate 2AS server while, at the same time, providing additional information about the session (such as the identity of the home agent or enterprise home agent, the identity of the enterprise, the identity of the session and other information that will assist the 2AS in determining the downstream identity management server to use).

When the 2AS receives the redirected session it then sends a form back to the wireless device to collect user identity and credential information. The wireless device facilitates completion of the form, and return of the completed form via HTTP(s) POST. The 2AS then forwards the credential information to the appropriate identity management server based on the information provided by the home agent or enterprise home agent. The 2AS receives a response from the identity management server and takes the appropriate action by either indicating to the home agent or enterprise home agent that the authentication was successful and the device should be allowed to use the resources protected by the 2AS process; or if the authentication is unsuccessful that the session(s) should be disconnected.

The invention provides a call flow where an agent on the wireless device initiates the connection by sending an HTTP(s) POST that includes the “user” identity and credentials. This HTTP(s) POST is not in response to a form that is provided to the wireless device from the 2AS, so the 2AS does not have a session with the wireless device. We refer to this as an “Unsolicited POST” operation.

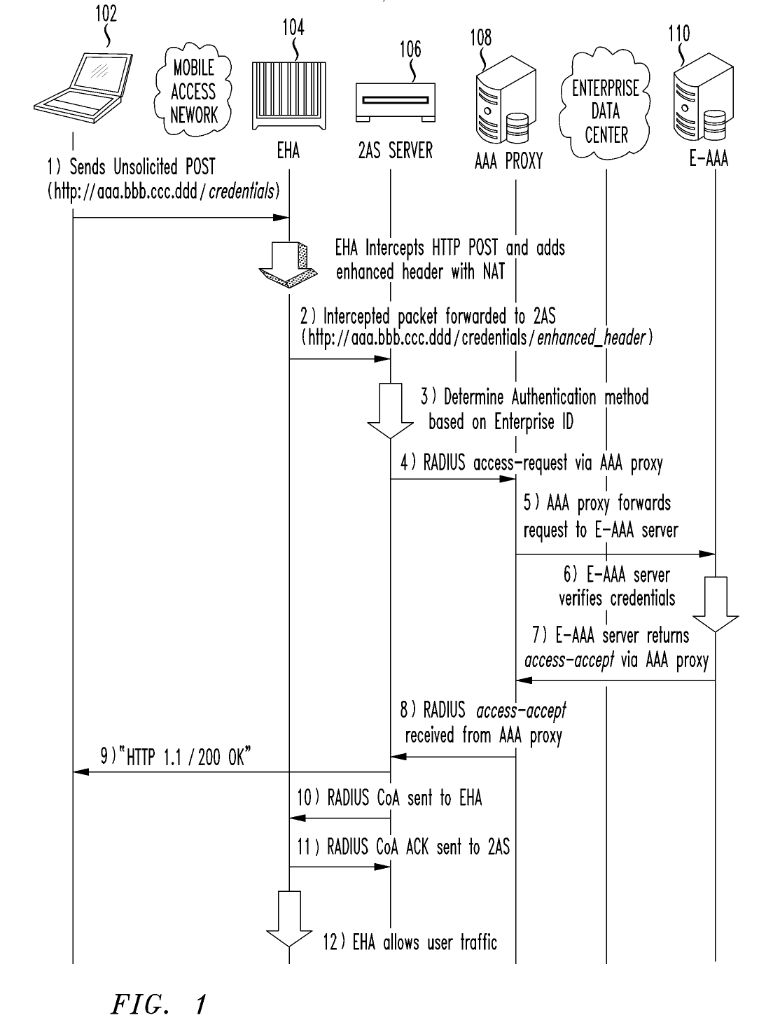

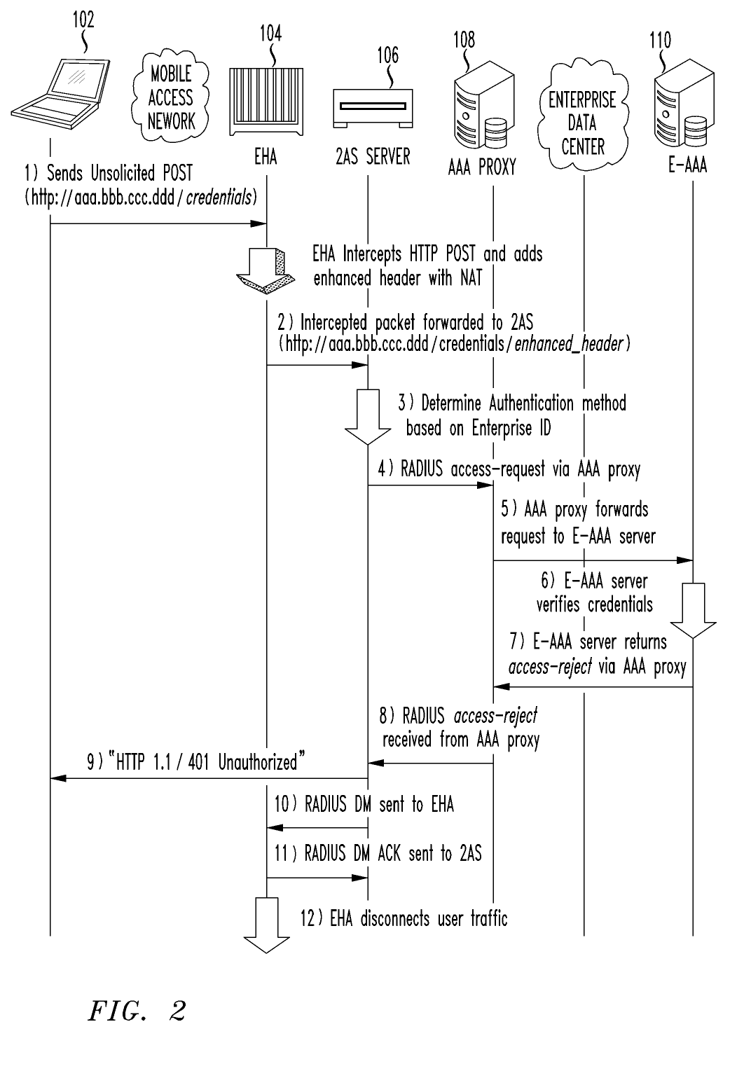

The “Unsolicited POST” is seen by the home agent or enterprise home agent and the HTTP(s) session that includes this operation is handled by the home agent or enterprise home agent in a similar way as an HTTP(s) session in the current call flow (i.e., forwarding the session to the appropriate 2AS server with the additional information regarding the identity of the home agent or enterprise home agent, and the enterprise). When the 2AS receives the “Unsolicited POST”, it uses the “user” identity and credentials from the POST and then completes interaction with the downstream identity management server. The 2AS receives a response from the identity management server and takes the appropriate action by either indicating to the home agent or enterprise home agent that the authentication was successful and the device is authorized to use the private enterprise network resources protected by the 2AS process; or if the authentication was unsuccessful that the session(s) should be disconnected. In addition, the 2AS may communicate with the agent on the wireless device to send intermediate and final status of the attempt as shown in the call flow diagrams of FIG. 1 and FIG. 2.

FIG. 1 shows a secondary authentication service (2AS) unsolicited POST successful operation, in accordance with the principles of the present invention.

In particular, as shown in step 1 of FIG. 1, the client device 102 sends an HTTP POST with the credential information.

In step 2, the enterprise home agent 104 intercepts the transaction, adds an enhanced header, performs NAT, and forwards the request to the 2AS server 106.

In step 3, the 2AS server 106 determines the authentication method based on Enterprise ID.

In step 4, the 2AS server 106 forwards the request to the appropriate authentication proxy 108.

In step 5, the authentication proxy 108 forwards the request to the enterprise access management system 110.

In step 6, the enterprise access management system 110 verifies credentials.

In step 7, the enterprise access management system 110 sends an “accept” to the authentication proxy 108.

In step 8, the authentication proxy 108 sends an appropriate “accept” message to the 2AS server 106.

In step 9, the 2AS server 106 sends a message, e.g., “200 OK” to the client device 102.

In step 10, the 2AS server 106 sends a CoA to the enterprise home agent 104.

In step 11, the enterprise home agent 104 sends a CoA ACK to the 2AS server 106.

In step 12, the enterprise home agent 104 admits the client device 102 to the system, having successfully passed the secondary authentication process.

FIG. 2 shows a secondary authentication service (2AS) unsolicited POST unsuccessful operation, in accordance with the principles of the present invention.

In particular, as shown in step 1 of FIG. 2, the client device 102 sends an HTTP POST with the credential information.

In step 2, the enterprise home agent 104 intercepts the transaction, adds an enhanced header, performs NAT and forwards the request to the 2AS server 106.

In step 3, the 2AS server 106 determines the authentication method based on Enterprise ID.

In step 4, the 2AS server 106 forwards the request to the appropriate authentication proxy 108.

In step 5, the authentication proxy 108 forwards the request to the enterprise access management system 110.

In step 6, the enterprise access management system 110 verifies credentials.

In step 7, the enterprise access management system 110 sends a “reject” to the authentication proxy 108. In step 8, the authentication proxy 108 sends an appropriate “reject” message to the 2AS server 106.

In step 9, the 2AS server 106 sends a “401 unauthorized” type message (or similar) to the client device 102.

In step 10, the 2AS server 106 sends a DM to the enterprise home agent 104.

In step 11, the enterprise home agent 104 sends a DM ACK to the 2AS server 106.

In step 12, the enterprise home agent 104 disconnects the client device 102 and refuses access to the system, having failed the secondary authentication process.

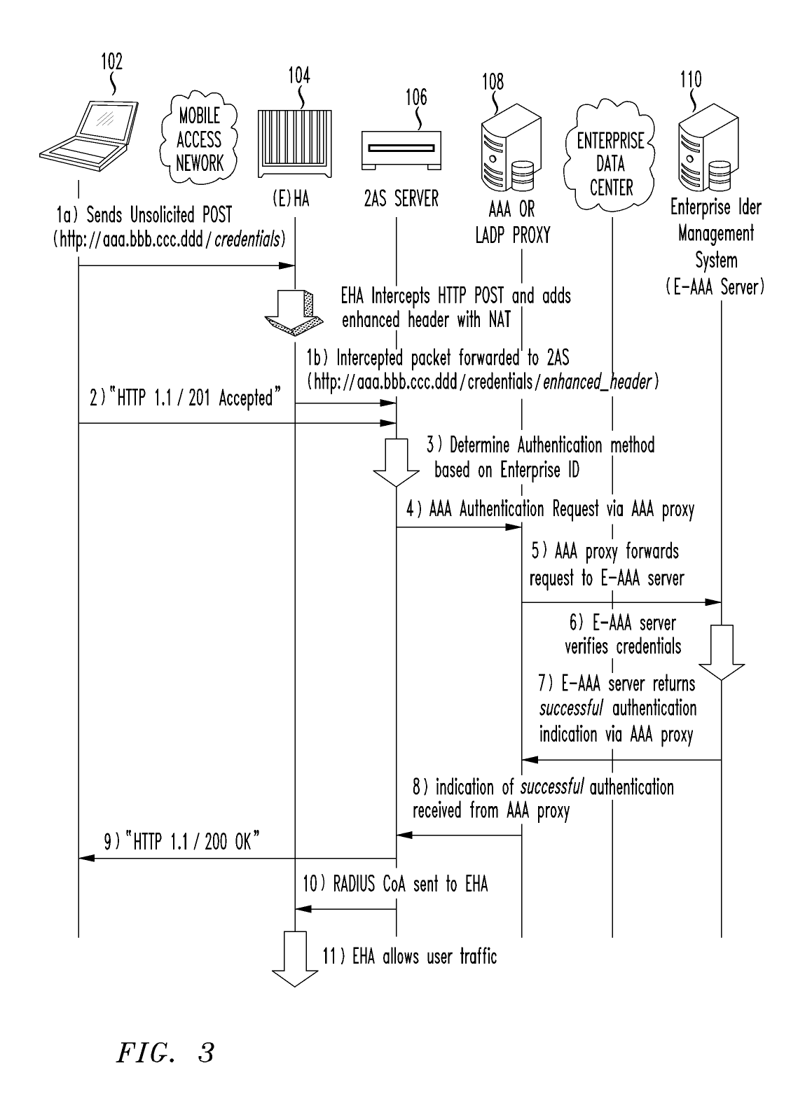

FIG. 3 shows an exemplary process call flow, in accordance with the principles of the present invention.

In particular, as shown in step 1a of FIG. 3, the client device 102 sends unsolicited POST (http://aaa.bbb.ccc.ddd/credentials) to the enterprise home agent 104. Thereafter the enterprise home agent 104 intercepts HTTP

Post and adds enhanced header with NAT.

In step 1b, the intercepted packet is forwarded from the enterprise home agent 104 to the 2AS server 106.

In step 2, the 2AS server 106 sends an “HTTP 1-1/201 Accepted” to the client device 102.

In step 3, authentication is determined based on enterprise ID.

In step 4, the 2AS server 106 sends an AAA authentication request via AAA proxy.

In step 5, in the authentication proxy 108, the AAA proxy forwards the request to the enterprise access management system 110.

In step 6, the enterprise access management system 110 verifies credentials.

In step 7, the enterprise access management system 110 returns successful authentication indication via the AAA proxy 108.

In step 8, the AAA proxy 108 provides an indication of successful authentication received from the AAA proxy 108.

In step 9, the 2AS server 106 sends an “HTTP1-1/200 OK” to the client device 102.

In step 10, the 2AS server 106 sends a RADIUS CoA to the enterprise home agent 104.

In step 11, the enterprise home agent 104 allows user traffic.

The present invention permits the otherwise conventional Secondary Authentication Service (2AS) to provide a bridge method to provide machine-to-machine (M2M) authentication services. The present invention has particular applicability for any wireless carrier that employs a Secondary Authentication Service (2AS). Moreover, it has applicability to any system that has the ability to use HTTP(s) POST to send user identity and credential information that is not in response to a form.

While the invention has been described with reference to the exemplary embodiments thereof, those skilled in the art will be able to make various modifications to the described embodiments of the invention without departing from the true spirit and scope of the invention.

What is claimed is:

1. A method for a wireless device to send identity and credential information in an unsolicited HTTP(s) POST operation without first having a session established to a secondary authentication service (2AS), comprising:
receiving an unsolicited HTTP(s) POST including a user identity and credentials from a wireless device which does not have a session with a relevant secondary authentication service;
using said user identity and credentials from said unsolicited HTTP(s) POST to complete interaction with a downstream management server on a wireless carrier network or in a private enterprise network;
receiving a response from an identity management server; and
based on said response, authorizing use of a private enterprise network resource protected by said secondary authentication service.

2. A secondary authentication service server, comprising:
an HTTP(s) POST receiver module to receive an unsolicited HTTP(s) POST including a user identity and credentials from a wireless device which does not have a session with a relevant secondary authentication service;
an interaction module to use said user identity and credentials from said unsolicited HTTP(s) POST to complete interaction with a downstream management server on a wireless carrier network or in a private enterprise network; and
an authorization module to authorize use of a private enterprise network resource protected by said secondary authentication service server based on a response from an identity management server.
whereby a wireless device is enabled to send identity and credential information in an unsolicited HTTP(s) POST operation without first having a session established to said secondary authentication service (2AS).
